(19) United States
(12) Patent Application Publication
(10) Pub. No.: US 2026/0214383 A1
(43) Pub. Date: Jul. 23, 2026

(54) APPARATUS, METHODS, AND COMPUTER PROGRAMS FOR AUDIO PROCESSING

(71) Applicant: Nokia Technologies Oy, Espoo (FI)

(72) Inventors: Khaldoon AL-NAIMI, Cambridge (GB); Alessandro MONTANARI, Cambridge (GB); Andrea FERLINI, Cambridge (GB)

(21) Appl. No.: 19/139,000

(22) PCT Filed: Nov. 28, 2023
(86) PCT No.: PCT/EP2023/083352

§ 371 Date: Jun. 13, 2025

(30) Foreign Application Priority Data
Dec. 19, 2022 (EP) 22214531.0

(51) Int. Cl. H04R 3/04; H04R 25/00

(52) U.S. Cl. CPC H04R 3/04; H04R 25/505; H04R 2430/01

(57) ABSTRACT

An apparatus comprising means for: determining that audio content for playing to a user comprises at least one prede-2024/132402 termined frequency; determining a plurality of frequencies, different to the at least one predetermined frequency, configured to cause the user to perceive audio output at the at least one predetermined frequency when the plurality of frequencies are output together to the user; and mixing the determined plurality of frequencies into the audio content to increase the perceived volume of the audio content at the at least one predetermined frequency, when the audio content is perceived by the user.

### TECHNOLOGICAL FIELD

Examples of the disclosure relate to apparatus, methods, and computer programs for audio processing. Some relate to apparatus, methods, and computer programs for audio processing in hearing sensitivity compensation.

### BACKGROUND

Some electronic devices are configured to perform audio processing. In some circumstances, audio processing can be limited by device configuration.

It would be desirable to improve audio processing in view of, for example, electronic device configuration.

### BRIEF SUMMARY

According to various, but not necessarily all, embodiments there is provided an apparatus comprising:
means for determining that audio content for playing to a user comprises at least one predetermined frequency;
means for determining a plurality of frequencies, different to the at least one predetermined frequency, configured to cause the user to perceive audio output at the at least one predetermined frequency when the plurality of frequencies are output together to the user; and
means for mixing the determined plurality of frequencies into the audio content to increase a perceived volume of the audio content at the at least one predetermined frequency, when the audio content is perceived by the user.

In some examples, determining a plurality of frequencies comprises determining a plurality of frequencies that are harmonically related to the at least one predetermined frequency.

In some examples, determining a plurality of frequencies comprises determining a plurality of frequencies configured to cause the user to perceive the at least one predetermined frequency as a psychoacoustic combination tone.

In some examples, determining a plurality of frequencies comprises filtering the audio content using a band-pass filter that is configured based, at least in part, on an audiometric sensitivity profile of a user to provide filtered audio content, and determining the plurality of frequencies based, at least in part, on the filtered audio content.

In some examples, the band-pass filter is configured to allow the at least one predetermined frequency to pass.

In some examples, determining a plurality of frequencies comprises filtering the filtered audio content and determined plurality of frequencies to remove the filtered audio content.

In some examples, the apparatus comprises means for adjusting the volume of the determined plurality of frequencies, prior to mixing, based, at least in part, on at least one of: audio content, audio content type, audio content volume or audio output capability.

In some examples, the means comprises
at least one processor; and
at least one memory including computer program code,
the at least one memory storing instructions that, when executed by the at least one processor, cause performance of the apparatus.

According to various, but not necessarily all, embodiments there is provided an electronic device comprising an apparatus as described herein.

According to various, but not necessarily all, embodiments there is provided a method comprising:
determining that audio content for playing to a user comprises at least one predetermined frequency;
determining a plurality of frequencies, different to the at least one predetermined frequency, configured to cause the user to perceive audio output at the at least one predetermined frequency when the plurality of frequencies are output together to the user; and
mixing the determined plurality of frequencies into the audio content to increase a perceived volume of the audio content at the at least one predetermined frequency, when the audio content is perceived by the user.
In some examples, determining a plurality of frequencies comprises determining a plurality of frequencies that are harmonically related to the at least one predetermined frequency.
In some examples, determining a plurality of frequencies comprises determining a plurality of frequencies configured to cause the user to perceive the at least one predetermined frequency as a psychoacoustic combination tone.
In some examples, determining a plurality of frequencies comprises filtering the audio content using a band-pass filter that is configured based, at least in part, on an audiometric sensitivity profile of a user to provide filtered audio content, and determining the plurality of frequencies based, at least in part, on the filtered audio content.
In some examples, the band-pass filter is configured to allow the at least one predetermined frequency to pass.
According to various, but not necessarily all, embodiments there is provided a computer program comprising instructions for causing an apparatus to perform:
determining that audio content for playing to a user comprises at least one predetermined frequency;
determining a plurality of frequencies, different to the at least one predetermined frequency, configured to cause the user to perceive audio output at the at least one predetermined frequency when the plurality of frequencies are output together to the user; and
mixing the determined plurality of frequencies into the audio content to increase a perceived volume of the audio content at the at least one predetermined frequency, when the audio content is perceived by the user.

In some examples, determining a plurality of frequencies comprises determining a plurality of frequencies that are harmonically related to the at least one predetermined frequency.

According to various, but not necessarily all, examples there is provided examples as claimed in the appended claims.

According to various, but not necessarily all, embodiments there is provided an apparatus comprising
at least one processor; and
at least one memory including computer program code;
the at least one memory storing instructions that, when executed by the at least one processor, cause the apparatus at least to perform at least a part of one or more methods disclosed herein.

According to various, but not necessarily all, embodiments there is provided an apparatus comprising means for performing at least part of one or more methods disclosed herein.

The description of a function should additionally be considered to also disclose any means suitable for performing that function.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

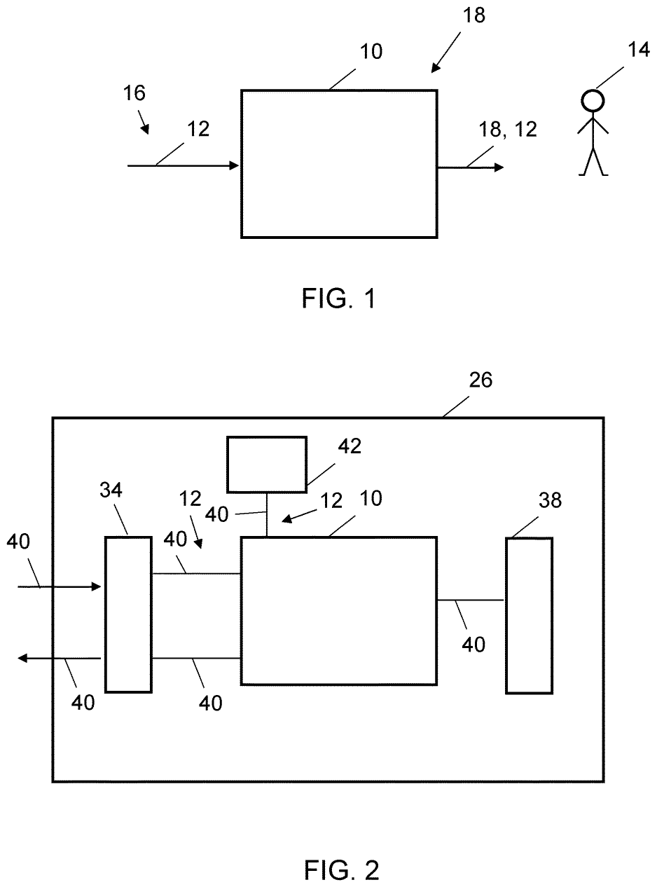

FIG. 1 shows an example of the subject matter described herein;

FIG. 2 shows another example of the subject matter described herein;

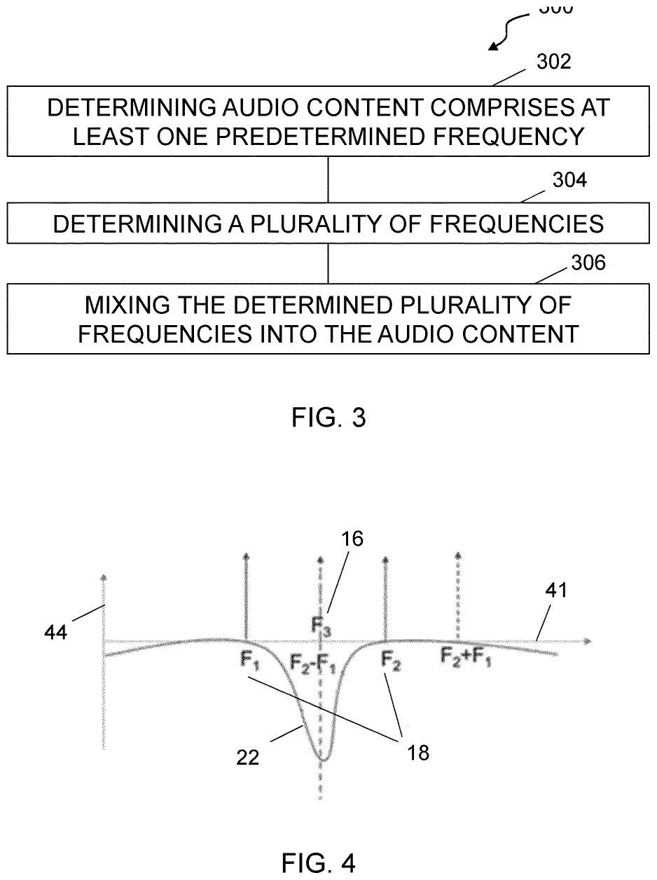

FIG. 3 shows another example of the subject matter described herein;

FIG. 4 shows another example of the subject matter described herein;

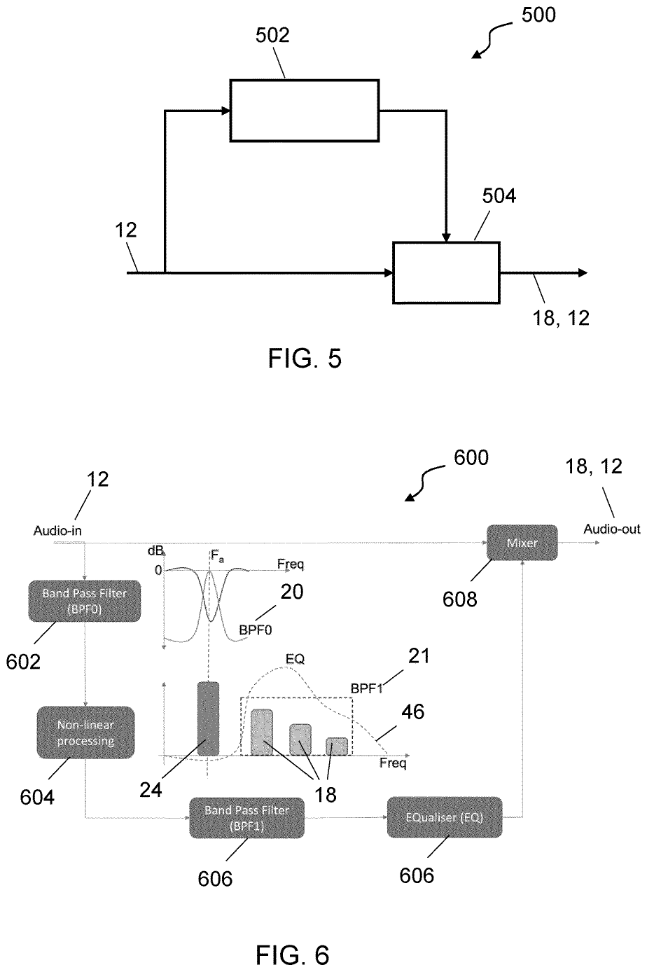

FIG. 5 shows another example of the subject matter described herein;

FIG. 6 shows another example of the subject matter described herein;

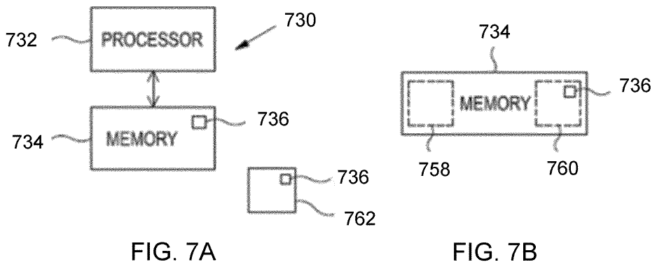

FIG. 7A shows another example of the subject matter described herein; and

FIG. 7B shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

Examples of the disclosure relate to apparatus, methods, and/or computer programs for and/or involved in audio processing.

The following description and FIGs describe various examples of an apparatus 10 comprising means for:
determining that audio content 12 for playing to a user 14 comprises at least one predetermined frequency 16;
determining a plurality of frequencies 18, different to the at least one predetermined frequency 16, configured to cause the user 14 to perceive audio output at the at least one predetermined frequency 16 when the plurality of frequencies 18 are output together to the user 14; and
mixing the determined plurality of frequencies 18 into the audio content 12 to increase the perceived volume of the audio content 12 at the at least one predetermined frequency 16, when the audio content 12 is perceived by the user 14.

The means can comprise at least one processor; and at least one memory including computer program code; the at least one memory storing instructions that, when executed by the at least one processor, cause the performance of the apparatus.

As used herein, an apparatus and/or device and/or component for performing one or more actions should also be considered to disclose an apparatus and/or device and/or component configured to perform the one or more actions.

Similarly, as used herein, an apparatus and/or device and/or component configured to perform one or more actions should also be considered to disclose an apparatus and/or device and/or component for performing the one or more actions.

FIG. 1 schematically illustrates an example of an apparatus 10.

Various features referred to in relation to FIG. 1 can be found in the other FIGs.

In the example of FIG. 1, the apparatus 10 is configured to determine that audio content 12 for playing to a user 14 comprises at least one predetermined frequency 16.

The apparatus 10 can be comprised and/or be integrated in a device or devices, which can be considered an electronic device 26 or devices 26. See, for example, FIG. 2.

The apparatus 10 can be comprised in any suitable device or devices.

The audio content 12 can be received from any suitable source or sources. For example, the audio content 12 can be received from at least one device that is separate from a device comprising the apparatus 10 (external source) and/or from at least one component of a device comprising the apparatus 10 (internal source).

In examples, it can be considered that the at least one input 12 is received from an external source and/or an internal source.

Accordingly, the apparatus 10 can be configured to receive the audio content 12 from any suitable source or sources, for example from at least one external source and/or at least one internal source.

The apparatus 10 can be considered a device and/or electronic device 26.

In examples, the apparatus 10 is configured to determine a plurality of frequencies 18, different to the at least one predetermined frequency 16, configured to cause the user 14 to perceive audio output at the at least one predetermined frequency 16 when the plurality of frequencies 18 are output together to the user 14.

Determining a plurality of frequencies 18 can comprise determining a plurality of frequencies 18 that are harmonically related to the at least one predetermined frequency 16.

Determining a plurality of frequencies 18 can comprise determining a plurality of frequencies 18 configured to cause the user 14 to perceive the at least one predetermined frequency as a psychoacoustic combination tone.

Determining a plurality of frequencies 18 can comprise filtering the audio content 12 using a band-pass filter 20 that is configured based, at least in part, on an audiometric sensitivity profile 22 of a user 14 to provide filtered audio content 24, and determining the plurality of frequencies 18 based, at least in part, on the filtered audio content 24.

In examples, the band-pass filter 20 is configured to allow the at least one predetermined frequency 16 to pass.

In some examples, determining a plurality of frequencies 18 comprises filtering the filtered audio content 24 and determined plurality of frequencies 18 to remove the filtered audio content 24.

In examples, the apparatus 10 is configured to mix the determined plurality of frequencies 18 into the audio content 12 to increase the perceived volume of the audio content 12 at the at least one predetermined frequency, when the audio content 12 is perceived by the user 14.

In examples, the apparatus 10 is configured to adjust the volume of the determined plurality of frequencies, prior to mixing, based, at least in part, on at least one of: audio content 12, audio content type, audio content volume and audio output capability.

In examples, the apparatus 10 is configured to cause and/or control output of the mixed plurality of frequencies 18 and the audio content 12 to the user 14.

In some examples, the apparatus 10 is configured to output the mixed plurality of frequencies 18 and audio content 12 to the user 14.

In examples, the apparatus 10 can comprise any number of additional elements not illustrated in the example of FIG. 1.

FIG. 2 schematically illustrates an example of an electronic device 26.

In the example of FIG. 2, the electronic device 26 comprises an apparatus 10 as described in relation to FIG. 1 and/or as described herein.

Consequently, FIG. 2 illustrates an example of an electronic device 26 comprising an apparatus 10 as described herein.

The electronic device 26 can comprise any suitable electronic device 26. For example, the electronic device 26 can comprise an output device, and/or a control device and so on.

The electronic device 26 can be and/or comprise any suitable personal device, and/or any suitable mobile device, and/or any suitable wearable device and so on.

For example, the electronic device 26 can be and/or comprise a hearing aid, at least one headphone, at least one earbud, a headset, a smartphone and so on.

In examples, the electronic device 26 can be considered an apparatus.

The at least one transceiver 34 can comprise any suitable transceiver 34 or transceivers 34. For example, the at least one transceiver 34 can comprise any suitable transceiver(s) 34 for transmitting and/or receiving one or more signals 40.

In examples, the at least one transceiver 34 is configured to transmit and/or receive one or more signals 40 using wired and/or wireless communication. Any suitable wired and/or wireless communication protocol(s) can be used. For example, Wi-Fi and/or Bluetooth can be used.

In some examples, one or more separate transmitters and receivers can be used.

In examples, the at least one transceiver 34 is configured to receive one or more signals 40 and transmit to the apparatus 10 the audio content 12.

In examples, the at least one transceiver 34 is configured to receive one or more signals 40 from the apparatus 10 to provide one or more audio outputs. For example, the at least one transceiver 34 can be configured to receive the mixed plurality of frequencies 18 and audio content 12 and transmit the mixed plurality of frequencies 18 and audio content 12 for output to a user 14.

The at least one component 42 can comprise any suitable component 42 or components 42 of the electronic device 26. For example, the at least one component 42 can comprise any suitable component(s) 42 configured to provide audio content 12. For example, the at least one component 42 can comprise a memory of the electronic device 26, a microphone and so on.

Accordingly, in examples the audio content 12 can be received via the transceiver 34 and/or from the component 42.

The component 42 can be considered an internal component of the electronic device 26.

The means for outputting 38 can comprise any suitable means for outputting audio to a user 14. For example, the means for outputting 38 can comprise any suitable means for outputting the mixed plurality of frequencies 18 and audio content 12 to a user 14.

The means for outputting 38 can be considered at least one audio output, at least one audio output mechanism, audio output circuitry, at least one component configured to output audio, at least one audio user interface, and/or at least one speaker and so on.

The means for outputting 38 can be configured to output audio, such as the mixed plurality of frequencies 18 and audio content 12. Accordingly, in examples, the electronic device 26 can be considered an output device 18.

The means for outputting 38 can, in examples, be considered a component 42 of the electronic device 26.

In examples, the apparatus 10 can provide at least one signal 40 to the means for outputting 38 to cause/control audio output, for example output of the mixed plurality of frequencies 18 and audio content 12.

Additionally, or alternatively, in examples the apparatus 10 can provide at least one signal 40 to the at least one transceiver 34 to cause/control audio output for example output of the mixed plurality of frequencies 18 and audio content 12.

In examples, the mixed plurality of frequencies 18 and audio content 12 can be stored in a memory for later retrieval and output to a user 14.

In examples, the electronic device 26 can comprise any number of additional elements not illustrated in the example of FIG. 2. For example, the electronic device 26 can comprise a display.

As illustrated in the example of FIG. 2, the at least one transceiver 34, the component 42 and the means for outputting 38 are operationally coupled to the apparatus 10 and any number of intervening elements can exist between them (including no intervening elements).

Additionally, or alternatively, one or more elements of the electronic apparatus 26 illustrated in the example of FIG. 2 can be integrated or combined.

FIG. 3 illustrates an example of a method 300.

One or more of the features discussed in relation to FIG. 3 can be found in one or more of the other FIGs.

In examples, method 300 can be considered a method of audio processing.

In examples, method 300 can be considered a method of improving and/or enhancing audio output.

In examples, method 300 can be considered a psychoacoustic audio processing method.

In examples, method 300 can be considered a method of compensating for hearing sensitivity loss of a user.

Method 300 can be performed by any suitable apparatus comprising any suitable means for performing the method 300.

In examples, method 300 can be performed by the apparatus of FIGS. 7A and 7B and/or the apparatus of FIG. 1 and/or the electronic device of FIG. 2.

At block 302, method 300 comprises determining that audio content 12 for playing to a user 14 comprises at least one predetermined frequency 16.

Block 302 can be performed in any suitable way using any suitable method. For example, block 302 can comprise processing and/or analysing audio content 12 in any suitable way to determine that audio content 12 comprises at least one predetermined frequency 16.

For example, a Fourier transform of the audio content 12 can be analysed to determine the magnitude of the audio content 12 at different frequencies.

For example, the audio content can be band pass filtered to the at least one predetermined frequency 16.

Audio content 12 can comprise any suitable audio content 12. For example, audio content 12 can comprise any suitable audio content 12 from any suitable source.

In examples, audio content 12 can be considered any content comprising one or more audio components.

In examples, audio content 12 can be considered any content comprising one or more sound components.

In examples, audio content 12 can comprise any audio content 12 that is to be played, and/or output, and/or presented to a user 14. For example, audio content 12 from a telecommunication call, music, video, situational awareness sounds and so on. In examples, audio content 12 can be streamed and/or retrieved from a memory of a device.

In examples, audio content 12 can be considered audio content 12 to be played to a user 14, and/or to be output to a user 14, and/or to be presented to a user 14 and so on.

In examples, method 300 comprises receiving the audio content 12.

The at least one predetermined frequency 16 can comprise any suitable frequency or frequencies.

The at least one predetermined frequency 16 can be determined in any suitable way using any suitable method.

In examples, the at least one predetermined frequency 16 comprises at least one frequency that has been selected for processing as part of method 300. For example, that at least one predetermined frequency 16 can comprise at least one frequency that has been selected for psychoacoustic processing.

In some examples, the at least one predetermined frequency 16 is associated with a user 14 to which the audio content 12 is to be output. For example, the at least one predetermined frequency 16 can be determined based, at least in part, on at least one auditory characteristic of a user 14.

In some examples, the at least one predetermined frequency 16 is determined based, at least in part, on an audiometric sensitivity profile 22 of a user 14. For example, the at least one predetermined frequency 16 can comprise, or be, at least one frequency at which the user 14 has reduced hearing sensitivity and/or has hearing loss as determined, for example, from an audiometric sensitivity profile 22 of a user 14.

Accordingly, in some examples, block 302 comprises determining that audio content 12 for playing to a user 14 comprises at least one predetermined frequency 16 at which the user 14 has reduced hearing sensitivity and/or at which the user 14 has hearing loss.

In examples, it can be considered that a user 14 has developed hearing loss at a frequency point/band when the sensitivity of that given frequency point/band is at least 25 dB below normal hearing sensitivity.

By way of example, reference is made to the example of FIG. 4.

The example of FIG. 4 illustrates an example of an audiometric sensitivity profile 22 of a user 14. In examples, an audiometric sensitivity profile 22 can be considered an auditory profile of a user 14.

An audiometric sensitivity profile 22 can be considered any information that is indicative of a user's hearing sensitivity with respect to at least one frequency.

In some examples, an audiometric sensitivity profile 22 can comprise an indication of at least one frequency at which a user 14 has reduced hearing sensitivity.

In some examples, an audiometric profile 22 can comprise an indication of a user's hearing sensitivity with respect to at least one frequency.

In some examples, an audiometric profile 22 can comprise an indication of a user's hearing sensitivity across a range of frequencies.

In some examples, an audiometric profile 22 can comprise an indication of a user's hearing sensitivity across the audible spectrum.

In the example of FIG. 4, the audiometric sensitivity profile provides an indication of a user's hearing sensitivity across a range of frequencies. In the illustrated example, frequency is shown on the x-axis 41 and sensitivity is shown on the y-axis 44. In the example of FIG. 4, frequency increases with increasing x value and sensitivity increases with increasing y value.

The audiometric sensitivity profile 22 in FIG. 4 shows a user's hearing sensitivity as a function of frequency. It can be seen that, in the illustrated example, the user has reduced hearing sensitivity at and/or around frequency F3.

Accordingly, in examples, frequency F3 can be determined as a predetermined frequency 16 based, at least in part, on the audiometric sensitivity profile 22 of the user 14.

The example of FIG. 4 will be discussed further below.

Returning to the example of FIG. 3, in some examples, method 300 comprises determining an audiometric sensitivity profile 22 of a user 14. Determining an audiometric sensitivity profile 22 of a user 22 can be performed in any suitable way using any suitable method.

In examples, the at least one predetermined frequency 16 can comprise at least one range and/or band of frequencies. For example, in the example of FIG. 3, the at least one predetermined frequency 16 can comprise a range/band of frequencies around frequency F3. For example, the range/band of frequencies can be a range/band of frequencies at which the user 14 has hearing sensitivity below a value.

At block 304, method 300 comprises determining a plurality of frequencies 18, different to the at least one predetermined frequency 16, configured to cause the user 14 to perceive audio output at the at least one predetermined frequency 16 when the plurality of frequencies 18 are output together to the user 14.

Block 304 can be performed in any suitable way using any suitable method. For example, any suitable method to determine a plurality of frequencies that, when output together to a user 14, cause the user 14 to perceive audio output at the at least one predetermined frequency 16 can be used.

The plurality of frequencies 18 can comprise any suitable frequencies. For example, the plurality of frequencies 18 can comprise any combination of frequencies, not including the predetermined frequency 16, that when output together to the user 14 cause the user 14 to perceive audio output at the at least one predetermined frequency 16.

In some examples, determining a plurality of frequencies 18 comprises determining a plurality of frequencies 18, different to the at least one predetermined frequency 16, that have a frequency relationship with the at least one predetermined frequency 16 such that when the plurality of frequencies 18 are output together to a user 14 the user 14 perceives audio output at the at least one predetermined frequency 16.

In some examples, determining a plurality of frequencies 18 comprises determining a plurality of frequencies 18 that are harmonically related to the at least one predetermined frequency 16.

The plurality of frequencies 18 can be harmonically related to the at least one predetermined frequency 16 in any suitable way. For example, the plurality of frequencies 18 can be harmonically related to the at least one predetermined frequency 16 such that the plurality of frequencies cause a user 14 to perceive the at least one predetermined frequency 16 when the plurality of frequencies are output together to a user 14.

In examples, the plurality of frequencies 18 have a psychoacoustic relationship with the predetermined at least one frequency.

In some examples, determining a plurality of frequencies 18 comprises determining a plurality of frequencies configured to cause the user to perceive the at least one predetermined frequency 16 as a psychoacoustic combination tone.

For example, the plurality of frequencies 18 can be determined as, at least, F1 and F2, to cause the user 14 to perceive the at least one predetermined frequency 16 as a psychoacoustic combination tone when a complex tone of F1 and F2 is output to the user 14.

Any suitable psychoacoustic combination tone relationship with the predetermined at least one frequency 16 can be used in determining the plurality of frequencies 18.

Any suitable sum or difference tone can be used.

For example, at least, F1 and F2 can be determined so that the user 14 perceives the at least one predetermined frequency 16 given by the combination tone relationship |F1−F2| or F1+F2.

Additionally, or alternatively, the combination tone relationship 2F1+F2, and/or 3F1−2F2, and/or 3F1+2F2 can be used and so on.

By way of example, reference is made to the example of FIG. 4.

As discussed above, in the example of FIG. 4, the user's audiometric sensitivity profile 22 identifies that the user 14 has reduced hearing sensitivity at frequency F3. In the example of FIG. 4, the plurality of frequencies 18 are determined as F1 and F2 which cause frequency F3 to be perceived by the user 14 when F1 and F2 are output together to the user 14 via the psychoacoustic combination tone relationship F2−F1.

In the example of FIG. 4, the frequency at which the user 14 would perceive the psychoacoustic combination tone via the psychoacoustic combination tone relationship F2+F1 is also shown.

In the example of FIG. 4, the plurality of frequencies 18 could be determined differently to cause frequency F3 to be perceived by the user 14 when F1 and F2 are output together to the user 14 via the psychoacoustic combination tone relationship F2+F1, or any other suitable psychoacoustic relationship.

Returning to the example of FIG. 3, if there are a plurality of choices for the plurality of frequencies 18, for example because there are multiple harmonic and/or psychoacoustic combination tone relationships that could be used to cause the user 14 to perceive the at least one predetermined frequency 16, determining a plurality of frequencies 18 can comprise determining which harmonic and/or psychoacoustic combination tone relationship to use to determine the plurality of frequencies 18.

Determining which harmonic and/or psychoacoustic combination tone relationship to use to determine the plurality of frequencies 18 can be performed in any suitable way using any suitable method.

In examples, determining which harmonic and/or psychoacoustic combination tone relationship to use to determine the plurality of frequencies 18 comprises determining which harmonic and/or psychoacoustic combination tone to use based, at least in part, on at least one of: system performance, audio content type, the presence of the plurality of frequencies 18 in the audio content 12, the absence of the plurality of frequencies 18 in the audio content 12 and so on

For example, a harmonic and/or psychoacoustic combination tone relationship can be chosen that causes the plurality of frequencies 18 to be less disruptive to the audio content 12 and/or that an output device is readily configured to and capable of outputting with the audio content 12.

In some examples, determining a plurality of frequencies 18 comprises filtering the audio content 12 using a band-pass filter 20 that is configured based, at least in part, on an audiometric sensitivity profile 22 of a user 14 to provide filtered audio content 24, and determining the plurality of frequencies 18 based, at least in part, on the filtered audio content 24.

Any suitable band-pass filter 20 that is configured based, at least in part, on an audiometric sensitivity profile 22 of a user 14 can be used.

In some examples, the band-pass filter 20 is configured to allow the at least one predetermined frequency 16 to pass.

For example, the band-pass filter 20 can be configured substantially as an inverse of an audiometric sensitivity profile 22 of a user 14.

For example, the band-pass filter 20 can have a transmission profile that is substantially the inverse of an audiometric sensitivity profile 22 of a user 14.

For example, the band-pass filter 20 can have at least one peak transmission frequency that substantially corresponds with the at least one predetermined frequency 16. See, for example, FIG. 6.

In some examples, determining a plurality of frequencies 18 comprises filtering the filtered audio content 24 and determined plurality of frequencies 18 to remove the filtered audio content 24. See, for example, FIG. 6.

Filtering the filtered audio content 24 and determined plurality of frequencies 18 to remove the filtered audio content 24 can be performed in any suitable way using any suitable method.

In examples, filtering the filtered audio content 24 and determined plurality of frequencies 18 comprises using a band-pass filter 21. In some examples, band-pass filter 21 can be considered a further band-pass filter 21. See, for example, FIG. 6.

Any suitable band-pass filter 21 that is configured to remove the filtered audio content 24 can be used. In examples, the band-pass filter 21 configured based, at least in part, on the band-pass filter 20 used to provide the filtered audio content 24. For example, band-pass filter 21 can be substantially the inverse of the band-pass filter 20 used to provide the filtered audio content 24.

In some examples, determining a plurality of frequencies 18 comprises non-linear processing. Any suitable non-linear processing can be used, for example square function of time samples or an absolute function can be used.

At block 306, method 300 comprises mixing the determined plurality of frequencies 18 into the audio content 12 to increase the perceived volume of the audio content 12 at the at least one predetermined frequency 16, when the audio content 12 is perceived by the user 14.

Consequently, FIG. 3 illustrates a method comprising:
determining that audio content 12 for playing to a user 14 comprises at least one predetermined frequency 16;
determining a plurality of frequencies 18, different to the at least one predetermined frequency 16, configured to cause the user 14 to perceive audio output at the at least one predetermined frequency 16 when the plurality of frequencies 18 are output together to the user 14; and
mixing the determined plurality of frequencies 18 into the audio content 12 to increase the perceived volume of the audio content 12 at the at least one predetermined frequency 16, when the audio content 12 is perceived by the user 14.

The combination of the determined plurality of frequencies 18 and the audio content 12 can be considered audio content 12, and/or updated audio content 12, and/or modified audio content 12 and/or mixed audio content 12 and so on.

In examples, mixing the determined plurality of frequencies 18 into the audio content 12 can be considered combining the determined plurality of frequencies 18 and the audio content 12, and/or merging the determined plurality of frequencies 18 into the audio content 12 and so on.

In examples, block 306 can comprise mixing the determined plurality of frequencies 18 into the audio content 12 to increase the perceived volume of the audio content 12 at the at least one predetermined frequency 16, when the audio content 12 is perceived by the user 14.

In examples, mixing the determined plurality of frequencies 18 into the audio content 12 to increase the apparent volume of the audio content 12 at the at least one predetermined frequency 16, when the audio content 12 is perceived by the user 14.

Block 306 can be performed in any suitable way using any suitable method.

For example, any suitable method to mix, and/or combine, and/or merge the determined plurality of frequencies 18 into the audio content 12 to increase the perceived volume of the audio content 12 at the at least one predetermined frequency 16, when the audio content 12 is perceived by the user 14 can be used.

In examples, the determined plurality of frequencies 18 are mixed into the audio content 12 in an appropriate way and/or at an appropriate time in the audio content 12 so that output of the determined plurality of frequencies 18 cause the user 14 to perceive the at least one predetermined frequency at an appropriate point in the audio content 12.

For example, with reference to the example of FIG. 3, frequencies F1 and F2 can be mixed into audio content so that the user 14 is caused to perceive frequency F3, via a harmonic relationship, at a portion of the audio content 12 when frequency F3 occurs.

This is advantageous as, for example, this allows a user 14 who has hearing loss at frequency F3 to perceive frequency F3 at an appropriate point in audio content 12, using frequencies F1 and F2 at which the user's hearing sensitivity is not reduced.

In some examples, method 300 comprises adjusting the volume of the determined plurality of frequencies 18, prior to mixing, based, at least in part, on at least one of: audio content 12, audio content type 12, audio content volume and audio output capacity.

Adjusting the volume of the determined plurality of frequencies 18 can be performed in any suitable way using any suitable method. Adjusting the volume of the determined plurality of frequencies 18 can be considered equalizing the determined plurality of frequencies 18.

In examples, the volume of the determined plurality of frequencies 18 can be adjusted in any suitable way.

For example, the volume of the determined plurality of frequencies 18 can be adjusted so that output of the determined plurality of frequencies 18 and/or harmonically related frequency or frequencies perceived by the user 14 is not disruptive to the audio content 12, and/or is suitable for the audio content 12 and/or audio content type and/or audio content volume.

For example, the volume of the determined plurality of frequencies 18 can be adjusted so that output of the determined plurality of frequencies 18 is consistent with audio output capability of an output device.

In some examples, method 300 comprises controlling output of the mixed determined plurality of frequencies 18 and audio content 12.

In some examples, method 300 comprises causing output of the mixed determined plurality of frequencies 18 and audio content 12.

In some examples, method 300 comprises outputting the mixed determined plurality of frequencies 18 and audio content 12.

FIG. 5 illustrates an example of a method 500.

Method 500 can be performed by any suitable apparatus comprising any suitable means for performing the method 500.

In examples, method 500 can be performed by the apparatus of FIGS. 7A and 7B and/or the apparatus of FIG. 1 and/or the electronic device of FIG. 2.

FIG. 5 can be considered to illustrate an example of a psychoacoustic processing chain.

In the example of FIG. 5 the audio content 12 is looked at (whether it is coming from a call, music streaming, situational awareness sounds and so on . . . ) and when it sees content in the frequency point/band where hearing sensitivity loss occurs, it will be pre-processed by a psychoacoustic processing unit (block 502) and then mixed to the original content (block 504) before being presented to the user 14

FIG. 6 illustrates an example of a method 600.

Method 600 can be performed by any suitable apparatus comprising any suitable means for performing the method 600.

In examples, method 600 can be performed by the apparatus of FIGS. 7A and 7B and/or the apparatus of FIG. 1 and/or the electronic device of FIG. 2.

FIG. 6 can be considered to illustrate an example of a psychoacoustic processing chain.

FIG. 6 illustrates processing steps to produce psychoacoustic content under the that enables the user 14 to hear that content again, even though the audiometric profile 22 of the user 14 suggests a hearing loss in that specific frequency (or band) exists.

In the example of FIG. 6, the psychoacoustics processing chain starts (block 602) with a band-pass filter (BPF0, item 20 in FIG. 6) which is designed based on the audiometric sensitivity profile 22 of the user 14.

At block 602, content in the audio content 12, for example speech or situational awareness sounds, that fall in the insensitive part of the user's spectrum is filtered by BPFO.

At block 604, the bandpass filtered content is then processed by a non-linear processing block which generates content 18 that is harmonically related to the original BPF0 output (as symbolised by the bars 1) in FIG. 6, which are harmonics of the original content 24).

Many non-linear methods can be used for harmonic generation, examples (but not the only approaches), are to use of a square function of time samples or an absolute function.

The output of the non-linear processing is then band-pass filtered (block 606) through BPF1 which removes the original content, leaving only the harmonically generated content 18. The content 18 will then be mixed (block 608) with the original audio after it has been equalized (block 606) (as shown by the dashed trace 46 in FIG. 6) for the enhanced effect of the psychoacoustics content.

Examples of the disclosure are advantageous and/or provide technical benefits.

For example, examples of the disclosure provide for a user to perceive at least one predetermined frequency in audio content using psychoacoustic methods.

For example, examples of the disclosure provide for perceived volume of at least one predetermined frequency to be increased where otherwise it would not be possible to do so due to device capability, such as amplifier headroom.

For example, examples of the disclosure provide for compensation of a user's hearing loss at at least one frequency using psychoacoustic methods where otherwise it would be necessary to reduce the overall volume of audio content due to device capability, such as amplifier headroom.

For example, a user may have hearing loss at frequency F3 but it is not possible to increase gain at frequency F3 sufficiently due to amplifier headroom restrictions, and examples of the disclosure can provide for increased perceived volume at F3 using psychoacoustic combination tones.

FIG. 7A illustrates an example of a controller 730 suitable for use in an apparatus, such as apparatus 10 of FIG. 1 and/or FIG. 2. In examples, controller 730 can be considered an apparatus 10.

Implementation of a controller 730 may be as controller circuitry. The controller 730 may be implemented in hardware alone, have certain aspects in software including firmware alone or can be a combination of hardware and software (including firmware).

As illustrated in FIG. 7A the controller 730 may be implemented using instructions that enable hardware functionality, for example, by using executable instructions of a computer program 736 in a general-purpose or special-purpose processor 732 that may be stored on a computer readable storage medium (disk, memory etc) to be executed by such a processor 732.

The processor 732 is configured to read from and write to the memory 734. The processor 732 may also comprise an output interface via which data and/or commands are output by the processor 732 and an input interface via which data and/or commands are input to the processor 732.

The memory 734 stores a computer program 736 comprising computer program instructions (computer program code) that controls the operation of the apparatus when loaded into the processor 732. The computer program instructions, of the computer program 736, provide the logic and routines that enables the apparatus to perform the methods illustrated in the accompanying Figs. The processor 732 by reading the memory 734 is able to load and execute the computer program 736.

The apparatus comprises:
at least one processor 732; and
at least one memory 734 including computer program code
the at least one memory 734 and the computer program code configured to, with the
at least one processor 732, cause the apparatus at least to perform:
   determining that audio content for playing to a user comprises at least one predetermined frequency;
   determining a plurality of frequencies, different to the at least one predetermined frequency, configured to cause the user to perceive audio output at the at least one predetermined frequency when the plurality of frequencies are output together to the user; and
   mixing the determined plurality of frequencies into the audio content to increase the perceived volume of the audio content at the at least one predetermined frequency, when the audio content is perceived by the user.

The apparatus comprises:
at least one processor 732; and
   at least one memory 734 including computer program code,
   the at least one memory storing instructions that, when executed by the at least one processor 732, cause the apparatus at least to:
   determining that audio content for playing to a user comprises at least one predetermined frequency;
   determining a plurality of frequencies, different to the at least one predetermined frequency, configured to cause the user to perceive audio output at the at least one predetermined frequency when the plurality of frequencies are output together to the user; and
   mixing the determined plurality of frequencies into the audio content to increase the perceived volume of the audio content at the at least one predetermined frequency, when the audio content is perceived by the user.

As illustrated in FIG. 7A, the computer program 736 may arrive at the apparatus via any suitable delivery mechanism 762. The delivery mechanism 762 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 736. The delivery mechanism may be a signal configured to reliably transfer the computer program 736. The apparatus may propagate or transmit the computer program 736 as a computer data signal.

Computer program instructions for causing an apparatus to perform at least the following or for performing at least the following:
determining that audio content for playing to a user comprises at least one predetermined frequency;
determining a plurality of frequencies, different to the at least one predetermined frequency, configured to cause the user to perceive audio output at the at least one predetermined frequency when the plurality of frequencies are output together to the user; and
mixing the determined plurality of frequencies into the audio content to increase the perceived volume of the audio content at the at least one predetermined frequency, when the audio content is perceived by the user.

The computer program instructions may be comprised in a computer program, a non-transitory computer readable medium, a computer program product, a machine readable medium. In some but not necessarily all examples, the computer program instructions may be distributed over more than one computer program.

Although the memory 734 is illustrated as a single component/circuitry it may be implemented as one or more separate components/circuitry some or all of which may be integrated/removable and/or may provide /rmanent/semi-permanent/ dynamic/cached storage.

In examples the memory 734 comprises a random-access memory 758 and a read only memory 760. In examples the computer program 736 can be stored in the read only memory 758. See, for example, FIG. 7B.

In examples the memory 734 can be split into random access memory 758 and read only memory 760.

Although the processor 732 is illustrated as a single component/circuitry it may be implemented as one or more separate components/circuitry some or all of which may be integrated/removable. The processor 732 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single /ulti-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 736. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

Thus, the apparatus can comprise means for:
determining that audio content for playing to a user comprises at least one predetermined frequency;
   determining a plurality of frequencies, different to the at least one predetermined frequency, configured to cause the user to perceive audio output at the at least one predetermined frequency when the plurality of frequencies are output together to the user; and
   mixing the determined plurality of frequencies into the audio content to increase the perceived volume of the audio content at the at least one predetermined frequency, when the audio content is perceived by the user.

In examples, an apparatus can comprise means for performing one or more methods, and/or at least part of one or more methods, as disclosed herein.

In examples, an apparatus can be configured to perform one or more methods, and/or at least part of one or more methods, as disclosed herein.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1-15. (canceled)

16. An apparatus comprising:
at least one processor; and
at least one memory storing instructions that, when executed by the at least one processor, cause the apparatus at least to:
determine that audio content for playing to a user comprises at least one predetermined frequency;
determine a plurality of frequencies, different to the at least one predetermined frequency, configured to cause the user to perceive audio output at the at least one predetermined frequency when the plurality of frequencies are output together to the user; and
mix the determined plurality of frequencies into the audio content to increase a perceived volume of the audio content at the at least one predetermined frequency, when the audio content is perceived by the user.

17. An apparatus as claimed in claim 16, wherein determining a plurality of frequencies comprises determining a plurality of frequencies that are harmonically related to the at least one predetermined frequency.

18. An apparatus as claimed in claim 16, wherein determining a plurality of frequencies comprises determining a plurality of frequencies configured to cause the user to perceive the at least one predetermined frequency as a psychoacoustic combination tone.

19. An apparatus as claimed in claim 16, wherein determining a plurality of frequencies comprises filtering the audio content using a band-pass filter that is configured based, at least in part, on an audiometric sensitivity profile of a user to provide filtered audio content, and determining the plurality of frequencies based, at least in part, on the filtered audio content.

20. An apparatus as claimed in claim 19, wherein the band-pass filter is configured to allow the at least one predetermined frequency to pass.

21. An apparatus as claimed in claim 19, wherein determining a plurality of frequencies comprises filtering the filtered audio content and determined plurality of frequencies to remove the filtered audio content.

22. An apparatus as claimed in claim 16, comprising means for adjusting the volume of the determined plurality of frequencies, prior to mixing, based, at least in part, on at least one of: audio content, audio content type, audio content volume or audio output capability.

23. An electronic device comprising an apparatus as claimed in claim 16.

24. A method comprising:
determining that audio content for playing to a user comprises at least one predetermined frequency;
determining a plurality of frequencies, different to the at least one predetermined frequency, configured to cause the user to perceive audio output at the at least one predetermined frequency when the plurality of frequencies are output together to the user; and
mixing the determined plurality of frequencies into the audio content to increase a perceived volume of the audio content at the at least one predetermined frequency, when the audio content is perceived by the user.

25. A method as claimed in claim 24, wherein determining a plurality of frequencies comprises determining a plurality of frequencies that are harmonically related to the at least one predetermined frequency.

26. A method as claimed in claim 24, wherein determining a plurality of frequencies comprises determining a plurality of frequencies configured to cause the user to perceive the at least one predetermined frequency as a psychoacoustic combination tone.

27. A method as claimed in claim 24, wherein determining a plurality of frequencies comprises filtering the audio content using a band-pass filter that is configured based, at least in part, on an audiometric sensitivity profile of a user to provide filtered audio content, and determining the plurality of frequencies based, at least in part, on the filtered audio content.

28. A method as claimed in claim 27, wherein the band-pass filter is configured to allow the at least one predetermined frequency to pass.

29. A non-transitory computer readable medium comprising program instructions stored thereon for performing at least the following:
determining that audio content for playing to a user comprises at least one predetermined frequency;
determining a plurality of frequencies, different to the at least one predetermined frequency, configured to cause the user to perceive audio output at the at least one predetermined frequency when the plurality of frequencies are output together to the user; and
mixing the determined plurality of frequencies into the audio content to increase a perceived volume of the audio content at the at least one predetermined frequency, when the audio content is perceived by the user.

30. A non-transitory computer readable medium as claimed in claim 29, wherein determining a plurality of frequencies comprises determining a plurality of frequencies that are harmonically related to the at least one predetermined frequency.
